(19) United States
(12) Patent Application Publication
(10) Pub. No.: US 2026/0226226 A1
(43) Pub. Date: Aug. 6, 2026

(54) A METHOD FOR OBTAINING A WATER-PROCESSABLE N-TYPE CONDUCTING POLYMER

(71) Applicant: WESTRA MATERIALS AB, Norrköping (SE)

(72) Inventors: Qifan Li, Norrköping (SE); Jun-Da Huang, Norrköping (SE); Chi-Yuan Yang, Norrköping (SE); Simone Fabiano, Norrköping (SE)

(73) Assignee: WESTRA MATERIALS AB, Norrköping (SE)

(21) Appl. No.: 19/149,266

(22) PCT Filed: Feb. 9, 2024
(86) PCT No.: PCT/EP2024/053304

§ 371 Date: Jul. 18, 2025

(30) Foreign Application Priority Data
Feb. 10, 2023 (WO) PCT/EP2023/53385

(51) Int. Cl. C08G 61/12; H01B 1/12

(52) U.S. Cl. CPC C08G 61/125; H01B 1/128; C08G 2261/3242; C08G 2261/334; C08G 2261/344; C08G 2261/43; C08G 2261/514

(57) ABSTRACT

The present invention relates to a method for manufacturing a water-processable n-type conducting polymer, the method comprising the steps of: a) adding a monomer to a solvent system comprising water in the presence of a catalyst and a base, thus providing a reaction solution; b) allowing the monomer to polymerize in the reaction solution thus obtaining an n-type conducting polymer; c) post-treating the n-type conducting polymer dispersion thus obtaining a water-processable n-type conducting polymer.

### TECHNICAL FIELD

The present invention relates to a method for manufacturing a water-processable n-type conducting polymer polymerized from water, a water-processable n-type conducting polymer obtained by such a method, and a water-based ink comprising the water-processable n-type conducting polymer obtained by such a method.

### BACKGROUND OF THE INVENTION

Water-based conducting polymer (CPs) inks have broad industrial applications, such as antistatic coatings, polymer capacitors, organic solar cells, displays (LCD/OLED), and printed electronics. PEDOT:PSS is a commercially available p-type (hole-transporting) water-based conducting polymer ink with a pristine electrical conductivity >1 S cm⁻¹, reaching values >4000 S cm⁻¹ after secondary doping or post-treating. Most of its success is due to its facile synthesis in water, exceptional water processability, and outstanding electrical performance. Applications in fields like bioelectronics and thermoelectric devices often necessitate the complementary use of both p-type and n-type (electron-transporting) materials. The availability of n-type materials amenable to water-based polymerization and processing remains limited. However, water-based n-type (electron-transporting) conducting polymers are crucial when considering complementary components in semiconducting devices and circuitry.

The BBL: PEI ethanol-based inks reported in WO 2022/106017 and WO 2022/106018 are the first step towards environmentally friendly solvent n-type inks. However, there are several problems partially limiting their application. First of all, ethanol has strict requirements for fire prevention during production, transportation, storage, and usage. Further, the inks disclosed in the above-referenced applications are mainly limited to deposition methods such as spray-casting, spin-casting and the like due to the large particle size. As may be gleaned from the above-cited references, the highest electrical conductivity of BBL: PEI inks is below 10 S cm⁻¹, which make them unsuitable for devices sensitive to sheet resistance.

Recently, Tang et al. achieved a milestone by synthesizing poly(3,7-dihydrobenzo[1,2-b: 4,5-b′]difuran-2,6-dione) (PBFDO) in DMSO, demonstrating unprecedented electrical conductivities exceeding 1000 S cm⁻¹ for an n-type polymer. Despite this remarkable conductivity, the purification steps of PBFDO necessitate substantial amounts of DMSO during the dialysis process. While this work marks a first step toward developing n-type conducting polymers processed with benign solvents, the reliance on DMSO, a solvent known for its adverse health effects, underscores the need for alternative approaches. Water, being the safest and most sustainable option, continues to be the preferred choice for the synthesis and processing of conductive inks for large-scale printed electronics.

Developing a water-based n-type CP ink with high conductivity, processability, and stability equivalent to PEDOT:PSS remains a challenging scientific and industrial endeavour with widespread impact in low-cost printed organic electronics.

### SUMMARY OF THE INVENTION

Considering the above, the present invention aims to solve the problems of the prior art. To this end, the present invention relates to a method for manufacturing a water-processable n-type conducting polymer polymerized in water, the method comprising the steps of:
a) adding a monomer to a solvent system comprising water in the presence of a catalyst and a base, thus providing a reaction solution;
b) allowing the monomer to polymerize in the reaction solution thus obtaining an n-type conducting polymer dispersion;
c) post-treating the n-type conducting polymer dispersion thus obtaining a water-processable n-type conducting polymer.

It should be noted that a catalyst precursor is also formed along with the water-processable n-type conducting polymer. The catalyst precursor is readily separable from the water-processable n-type conducting polymer, and may be recycled, as will be described in greater detail below.

The monomer has the central symmetrical benzene ring as the skeleton, active hydrogen and at least one electron-withdrawing group at the benzylic position.

The electron-withdrawing groups may be carbonyl, carboxyl, amide, alkoxy acyl or the like.

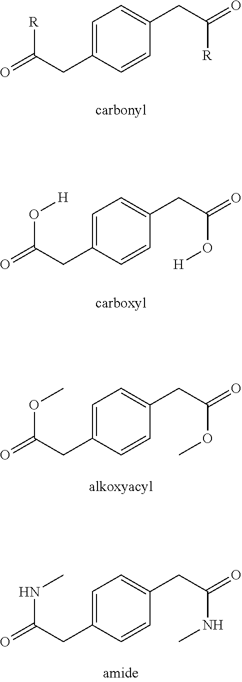

Further, the monomer may be in the form of a heterocyclic moiety having a central symmetrical benzene ring fused with at least one, preferably at least two rings, preferably five-membered rings. The monomer further comprises an active hydrogen and at least one electron-withdrawing group at the benzylic position. In particular, the monomer may be 3,7-dihydrobenzo[1,2-b: 4,5-b′]difuran-2,6-dione (HBFDO), 5,7-dihydropyrrolo[2,3-f]indole-2,6 (1H,3H)-dione, or 3,7-dihydrobenzo[1,2-b: 4,5-b′]dithiophene-2,6-dione.

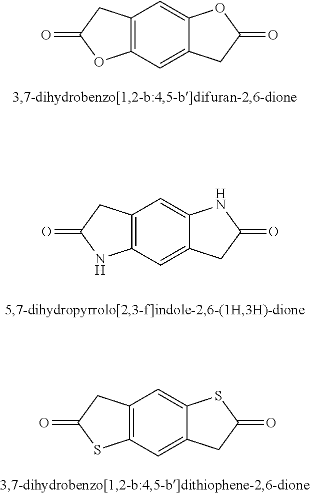 [SMILES: O=C1Cc2cc3c(cc2O1)CC(=O)O3 ; O=C1Cc2cc3c(cc2N1)CC(=O)N3 ; O=C1Cc2cc3c(cc2S1)CC(=O)S3]

In particular, the monomer is 3,7-dihydrobenzo[1,2-b: 4,5-b′]difuran-2,6-dione (HBFDO). In such an embodiment, the n-type conducting polymer may be poly[(2,2′-(2,5-dihydroxy-1,4-phenylene)diacetic acid)-co-3,7-dihydrobenzo[1,2-b: 4,5-b′]difuran-2,6-dione] (PDADF), poly[(2,2′-(2,5-dihydroxy-1,4-phenylene)diacetic acid) (PDADF-P), or mixture thereof. The structure of PDADF-P is similar to the structure of PDADF, but lack heterocyclic segments. In PDADF, m and n are integers that may be same or different. The general overview of the method of the present invention may be summarized as follows:

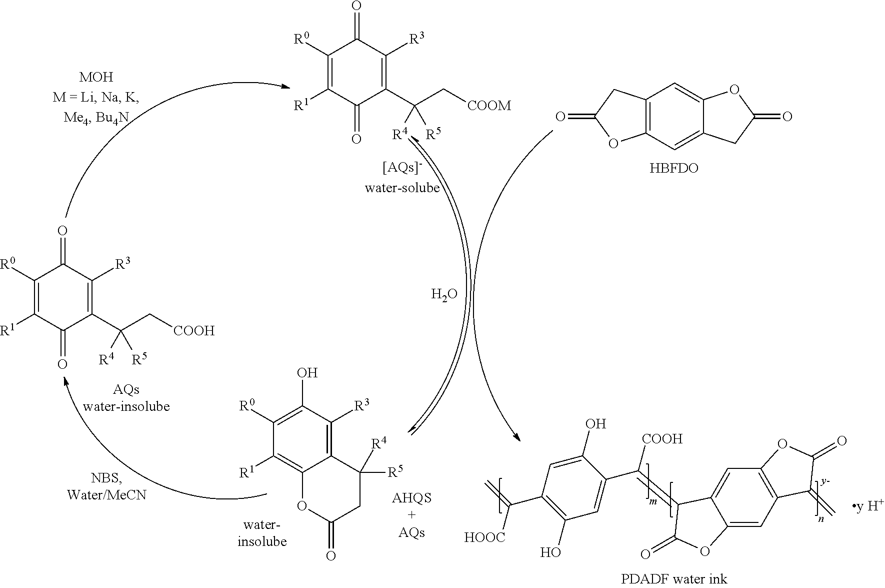

wherein AQs is the catalyst, as will be described in further detail below.

According to the present invention, the solvent system may consist of water. In other words, the solvent system comprises substantially only water, e.g. at least 99 vol % water. Such an embodiment offers the advantage of a cost-efficient and environmentally friendly manufacturing method.

The catalyst of the present invention should comprise a polar group. In particular, the catalyst according to the present invention may be selected from carboxyl- and sulfonyl-substituted benzoquinones (AQs). IN other words, the catalyst according to the present invention comprises a benzoquinone core structure and at least one substituent comprising a carboxyl moiety (—COOH) or a sulfonyl moiety (—SO₃H). It should be noted that the catalyst may comprise a plurality of substituents, which may be same or different. This catalyst can be efficiently isolated, recovered and recycled after polymerization and consistently yields water-processable n-type conducting polymer with similar electrical performance as the virgin water-processable n-type conducting polymer, i.e. the polymer manufactured using the non-recycled catalyst.

In particular, the catalyst may have the following structure:

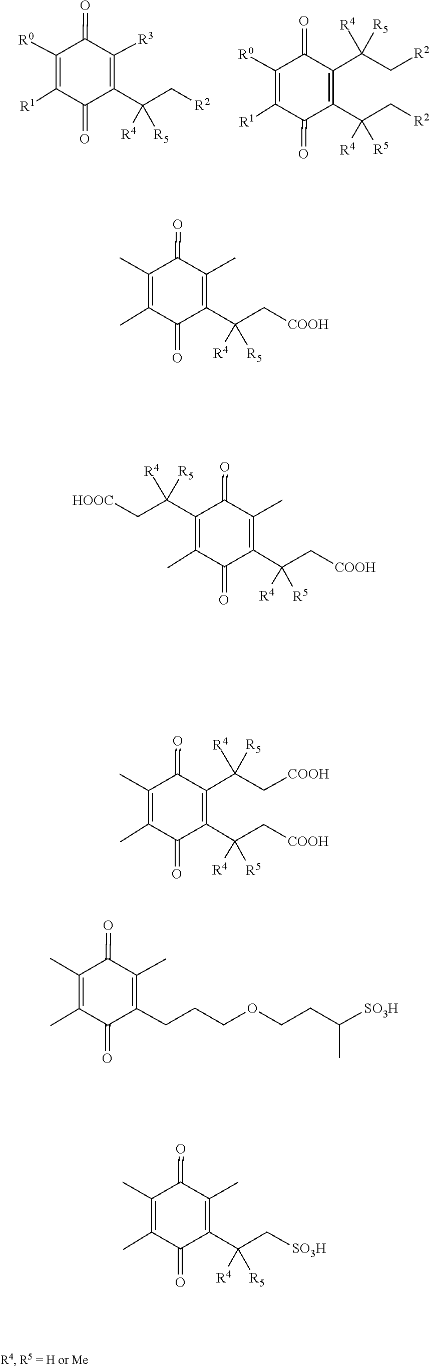

wherein R₀, R₁ and R₃ are independently H, Me, or —CH₂R₄R₅COOH;
R₄, R₅ are independently H or Me;
R₂ is —COOH or —SO₂OH.

Particularly preferable catalyst may be selected the group consisting of 3-(2,4,5-trimethyl-3,6-dioxocyclohexa-1,4-dien-1-yl)propanoic acid (TMQ-PA, R⁰═R¹═R³=Me, R₄═R₅═H, R₂═—COOH), 3,3′-(4,5-dimethyl-3,6-dioxocyclohexa-1,4-diene-1,2-diyl)dipropionic acid (AAMMQ, R₀═R₁=Me, R₃═—CH₂R₄R₅COOH, R₄, R₅═H or Me, R₂═—COOH), 3,3′-(2,5-dimethyl-3,6-dioxocyclohexa-1,4-diene-1,4-diyl)dipropionic acid (AMAMQ, R₁═R₃=Me, R₀═—CH₂R₄R₅COOH, R₄, R₅═H or Me, R₂═—COOH) and combinations thereof.

The base, i.e. a proton acceptor, is added to the reaction solution together with the monomer and the catalyst, or immediately after the addition of the monomer and the catalyst. The base is added in order to solubilize the catalyst in the solvent system. Further, the catalyst and the base may be added first and stirred for few minutes, following by adding the monomer. The base may in particular be MOH, wherein M is selected from Li⁺, Na⁺, K⁺, Me₄N⁺, Bu₄N⁺ or combination thereof.

The catalysts, also referred to as AQs, can be synthesized by Michael addition followed by oxidation with N-bromosuccinimide (NBS), as is described in greater detail below. AQs are highly crystalline water-insoluble organic acids. However, when they are neutralized with strong bases, AQs will be converted into highly water-soluble [AQs]⁻. When the solvent system consists of water, [AQs]⁻ can catalyse the polymerization of water-insoluble HBFDO monomer into water-processable PDADF. It is remarkable that after the polymerization, the aqueous solution becomes strongly acidic, and the [AQs]⁻ will be converted into water-insoluble AHQs and AQs, which can be separated from the PDADF ink by simple solvent extraction. The mix of AHQs and AQs can be converted into pure AQs by mild oxidation. Consequently, AQs are readily recyclable, thus offering the advantage of cost-efficiency and low environmental impact.

The catalyst may be manufactured using the following synthetic route:

### Synthesis Route to Catalysts AQs:

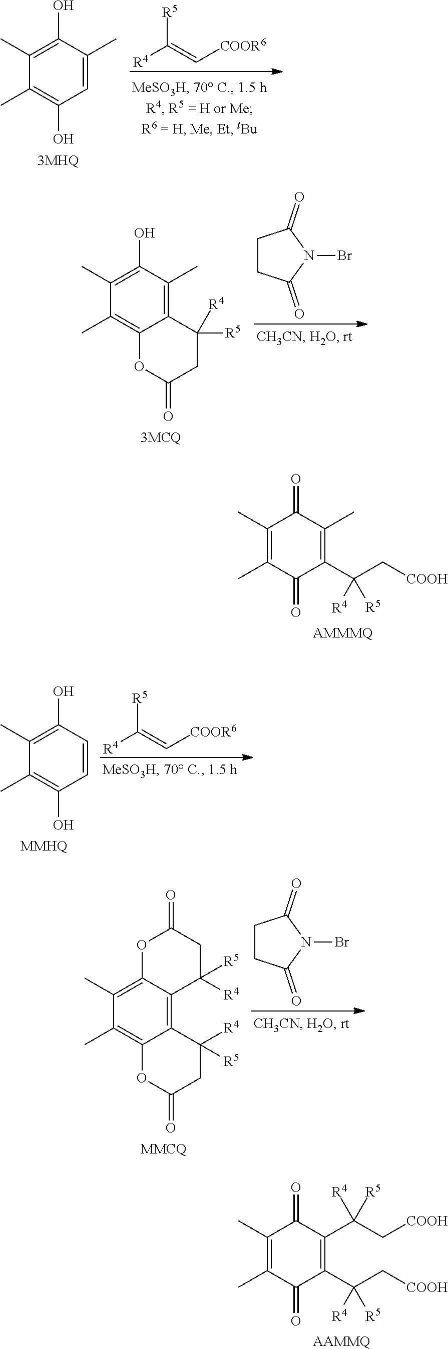

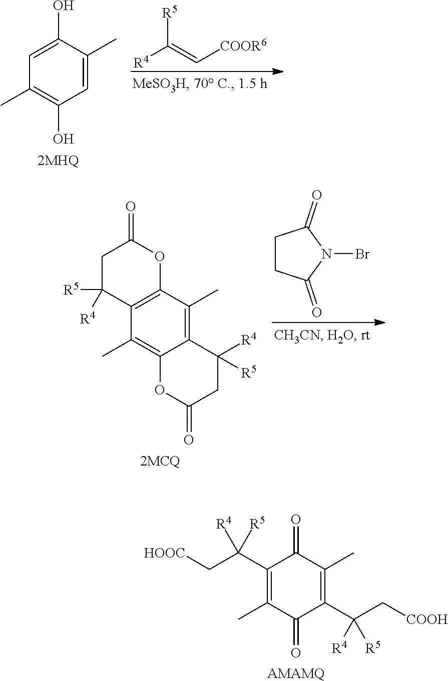

Step c) may be performed by solvent extraction, e.g. by addition of diethyl ether. In such an embodiment, the catalyst dissolves in organic phase and polymer in aqueous phase.

Additionally, the method may further comprise a step of:
a′) adding a surfactant to the reaction solution.

Step a′) may occur during or immediately after step a). In other words, the surfactant may be added to the reaction solution together with the monomer, the catalyst and optionally the base, or after the polymerization and purification process.

As may be understood from above, the surfactant is not essential for the method according to the first embodiment. However, the surfactant must be added if the polymer is intended to be used for spin-casting and if the catalyst comprises carboxylic substituents. However, spin-casting may be performed without the addition of a surfactant if the catalyst comprises sulfonyl substituents. Further, the surfactant may be added for enhancing electrical properties by modifying thin film morphology and surface roughness.

The surfactant may be selected from polyethylene glycol (PEG), polyvinylpyrrolidone (PVP), polyvinyl alcohol (PVA), sodium polystyrene sulfonate (PSSNa), poly(styrene sulfonate) acid (PSSH), sodium dodecylbenzenesulfonate (DBSNa), polyquaternium-4 (PQ-4), polyquaternium-10 (PQ-10), polydiallyldimethylammonium chloride (PDADMAC), polydiallyldiethylammonium chloride (PDADEAC), TWEEN®20, TWEEN®80, K-Carrageenan, PEG-PPG-PEG, Polyoxyethylene (10) tridecyl ether, Triton™ X-100 or combination thereof.

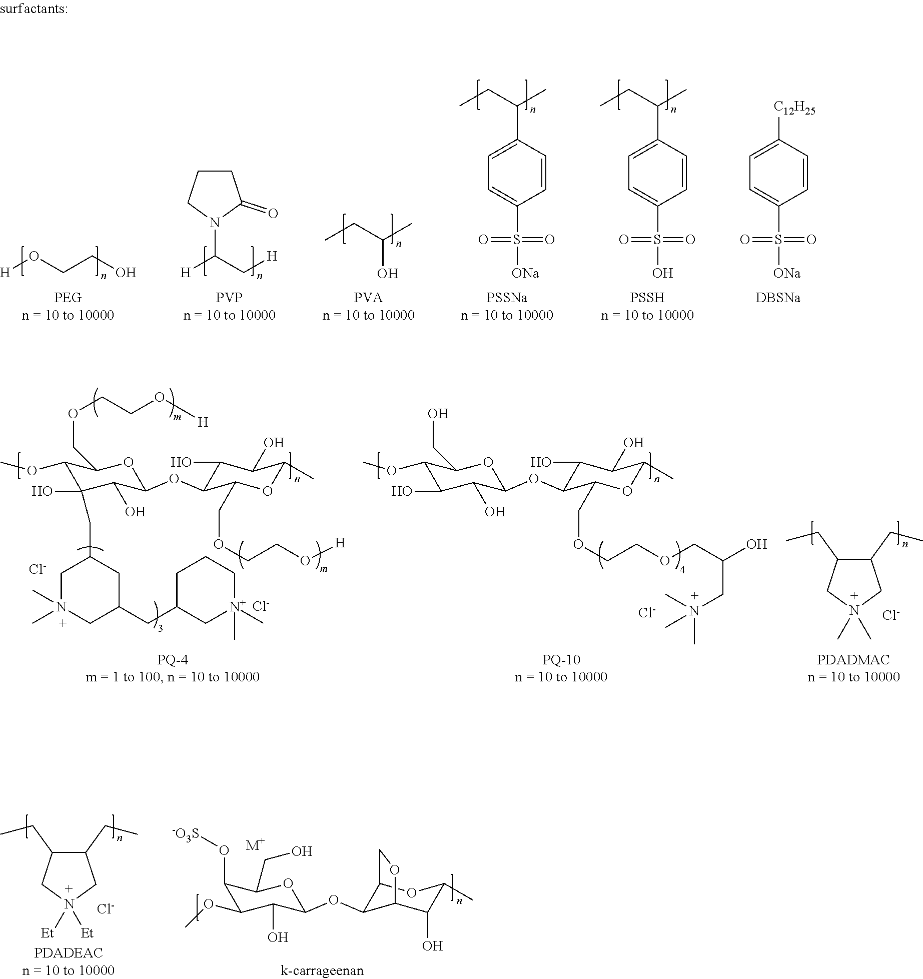

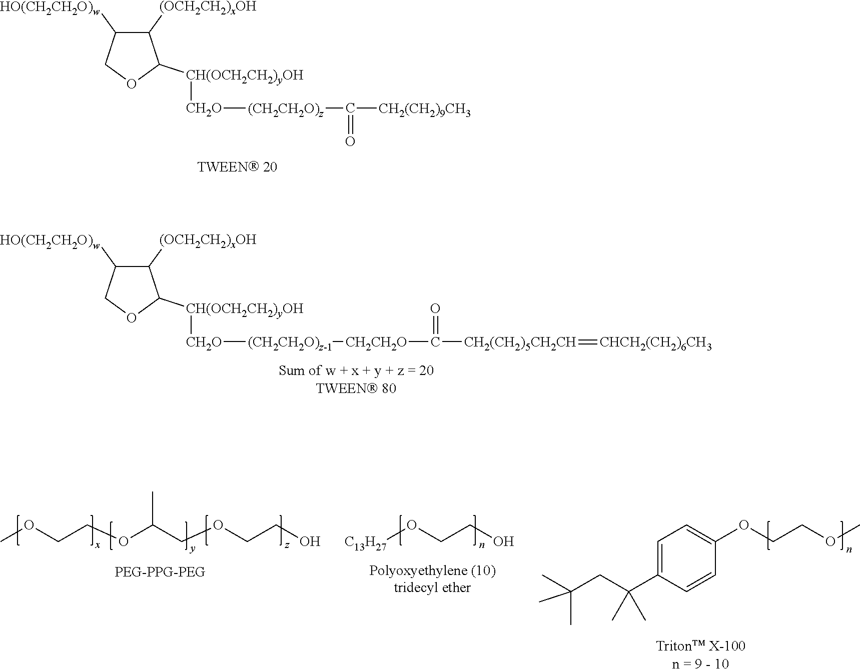

According to the present invention, the solvent system may comprise a polar aprotic solvent. In such an embodiment, the method further comprises the step of:

d) solvent exchanging such that the polar aprotic solvent is removed.

The polar aprotic solvent may be dimethyl sulfoxide (DMSO), dimethyl formamide (DMF), dimethyl acetamide (DMA) or a combination thereof. The ratio between water and the polar aprotic solvent may be from 10:90 to 90:10, preferably from 40:60 to 60:40.

When the solvent system comprises a polar aprotic solvent, the catalyst may be a quinone oxidant selected from tetramethyl benzoquinone (TMQ), alkyl-, sulfonyl- and carboxyl-substituted benzoquinones (AQs), or combination thereof.

The polymerization step, i.e. step b) may occur at a temperature from 20° C. to 150° C.

As mentioned above, the method of the present invention may further comprise a step of:
c′) removing the catalyst by extraction, oxidation and recycling the catalyst.

Finally, the method of the present invention may comprise additional steps, e.g. post-processing and purification steps. Such steps may also be performed in water.

The present invention further relates to a water-processable n-type conducting polymer comprising the general conjugated structure having a central symmetrical benzene ring fused with two rings, preferably five-membered rings, wherein the rings fused with the benzene ring preferably comprise a heteroatom, such as O, N or S. The water-processable n-type conducting polymer further comprises segments having a benzene ring comprising at least one substituent having a relatively electronegative element, e.g. O, N or S attached by a single bond to carbon, wherein each substituent has an acidic hydrogen. In particular, the water-processable n-type conducting polymer may be poly[(2,2′-(2,5-dihydroxy-1,4-phenylene)diacetic acid)-co-3,7-dihydrobenzo[1,2-b:4,5-b′]difuran-2,6-dione](PDADF), poly[(2,2′-(2,5-dihydroxy-1,4-phenylene)diacetic acid) (PDADF-P), or mixture thereof.

The polymer according to the present invention may be obtainable by the method described above.

Moreover, the present invention relates to a water-based n-type conducting ink comprising the water-processable n-type conducting polymer as mentioned above.

The n-type conducting ink of the present invention may thus be spin-coated or drop-cast in air and ambient temperature, forming the film having thicknesses from 1 nm to 1 cm, more preferably from 10 nm to 10 μm. Such a film may exhibit electrical conductivity in the order of 60 S/cm.

The present invention further relates to an organic optical or electronic device comprising the n-type conducting polymer described above.

As mentioned above, the n-type water-based conducting ink according to the present invention may be used in an organic optical or electronic device, such as OECTs, thermoelectric devices, ternary logic inverters, OPVs, OLEDs, organic supercapacitors, batteries, fuel cells, sensors and memories.

### BRIEF DESCRIPTION OF THE DRAWINGS

Embodiments of the invention will now be described by way of example with reference to the accompanying drawings, of which:

FIG. 1 shows schematic diagram for synthesis of PBFDO and PDADF by the designed catalyst TMQ-PA;

FIG. 2 depicts the polymers of the present invention;

FIG. 3 shows (a) Synthetic route for new catalyst TMQ-PA; (b) Possible reaction pathway of PDADF polymerization and catalyst recycling; (c) 1H NMR spectra of recycled catalyst;

FIG. 4 depicts identification of PBFDO synthesized from TMQ and TMQ-PA by spectroscopic characterization: (a) UV-vis spectra of PBFDO and PDADF (50 wt % TW80), (b) FTIR spectra of PBFDO synthesized from TMQ and TMQ-PA;

FIG. 5 illustrates FTIR and XPS spectral analysis of PBFDO and PDADF. (a) FTIR spectrum comparison between PBFDO and PDADF, offset (b) FTIR spectrum comparison between PDADF and Na substituted HPDA, offset. XPS spectra of PBFDO (c, e) and PDADF (d, f);

FIG. 6 shows FTIR spectra. (a) Adding 1 equivalent of NaOH to HBFDO water dispersion, forming fully ring-opened structure HPDA-Na. (b) Different mass ratio of HPDA were added to 5 mg/mL PBFDO DMSO ink and stirring for overnight, casting to film and their FTIR spectra were measured;

FIG. 7 depicts X-ray absorption spectroscopy (XAS) probing the transition from C and O core levels to the unoccupied states of PDADF and PBFDO.

FIG. 8 illustrates electrical properties and characterization of a TEG composed of a PDADF n-type leg and a PEDOT:PSS p-type leg. (a) Electrical conductivity. (b) Conductivity comparison of n-type CPs based on processing solvent. (c) Normalized PDADF (50 wt % TW80) thin film conductivity as a function of time stored at ambient. (d) Output voltage and power of the TEG at different temperature differences. (e) Accompanying open circuit voltage and short circuit current. (f) Output power of TEG with gold contacts for different temperature gradients;

FIG. 9 depicts microstructure Atomic Force Microscope (AFM) height images of PBFDO synthesized from different catalyst from TMQ and from TMQ-PA; AFM height images of PDADF and PDADF (50 wt % TW80) synthesized from water.

FIG. 10 illustrates 2D grazing-incidence wide-angle X-ray scattering (GIWAXS) patterns of PBFDO (a, b) and PDADF (c, d).

FIG. 11 shows (a) In-plane and (b) Out-of-plane GIWAXS line cuts of PBFDO (by TMQ or TMQ-PA), PDADF and PDADF (50 wt % TW80) films.

Table 1 depicts summary of calculated π-π stacking and lamellar distances and FWHM of (010) and (100) peaks from GIWAXS 1D data.

FIG. 12 illustrates Seebeck coefficient measurement of PBFDO, PDADF, PDADF (50 wt % TW80). The negative value indicates the n-type character of these polymers;

FIGS. 13 and 14 demonstrate thermal stability of PDADF;

FIG. 15 illustrates internal resistance of the OTEG according to the present invention.

### DETAILED DESCRIPTION OF THE INVENTION

As mentioned above, the present invention provides a method for manufacturing a water-processable n-type conducting polymer, the method comprising the steps of:
a) adding a monomer to a solvent system comprising water in the presence of a catalyst and a base, thus providing a reaction solution;
b) allowing the monomer to polymerize in the reaction solution thus obtaining an n-type conducting polymer dispersion;
c) post-treating the n-type conducting polymer dispersion thus obtaining a water-processable n-type conducting polymer.

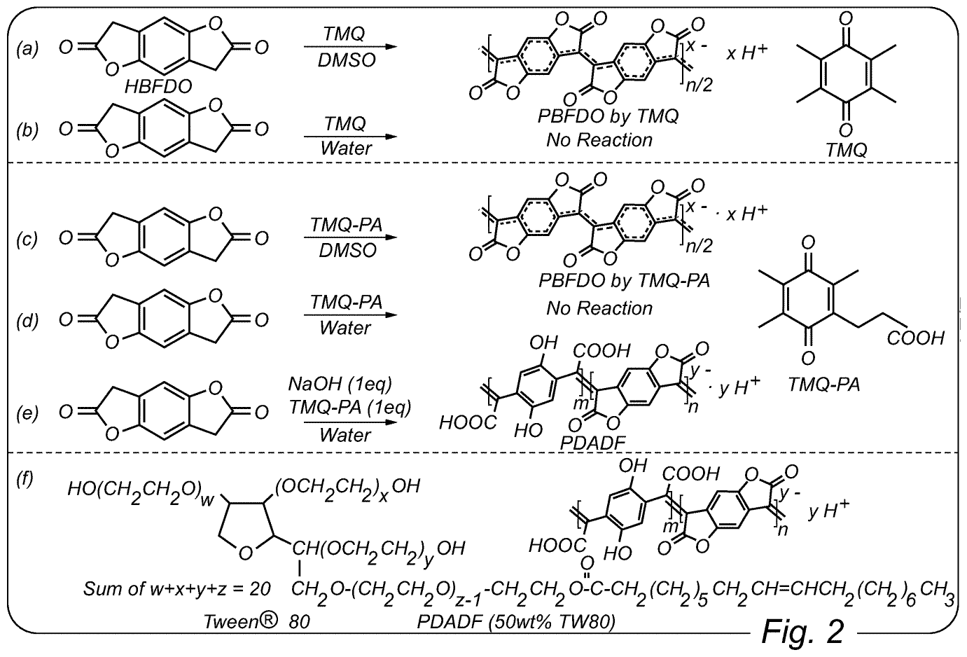

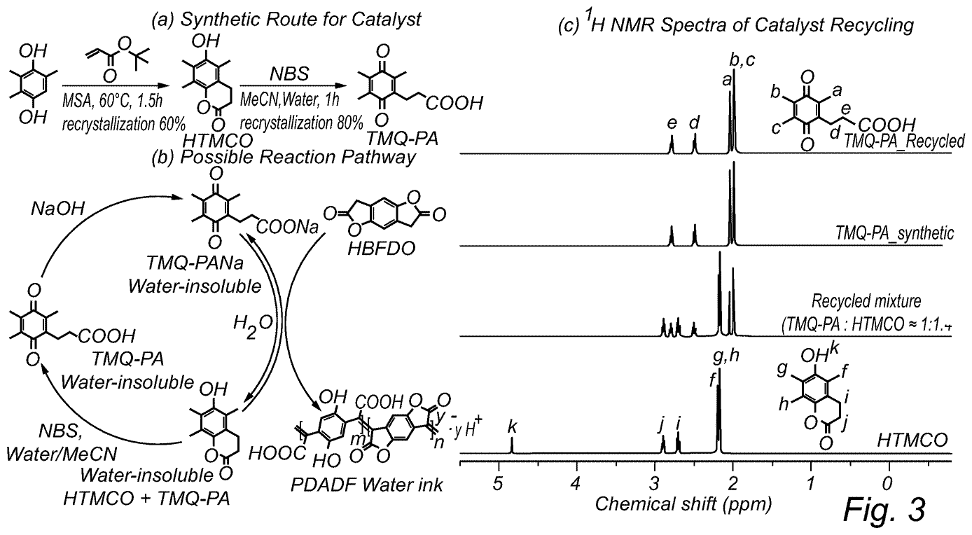

FIG. 2 depicts polymers described in the present application. Thus, FIG. 2a shows synthesis of PBFDO from DMSO by using TMQ as catalyst according to the reported method. Attempts to polymerize HBFDO directly from water using duroquinone (TMQ) as the oxidant failed because of the poor solubility of TMQ in water, which yields the formation of a reddish-brown mixture and no polymerization (FIG. 2b). To address this issue, a carboxyl group was introduced to TMQ to enhance its water solubility using the synthetic approach shown in FIG. 3a. TMQ-PA (3-(2,4,5-trimethyl-3,6-dioxocyclohexa-1,4-dien-1-yl)propanoic acid) was synthesized in two steps with an overall yield of 48%.

Synthesis of PBFDO from DMSO by using TMQ-PA as catalyst indicates that TMQ-PA has the ability to drive the polymerization and in-situ doping (FIG. 2c). However, no polymer could be found when water replaced DMSO in the same conditions as (c) (FIG. 2d). PDADF could be obtained from water polymerization when 1 equivalent NaOH was used, as may be seen in FIG. 2e. Addition of surfactant Tween 80 (TW80) into PDADF final water ink forms PDADF (50 wt % TW80), as shown in FIG. 2f.

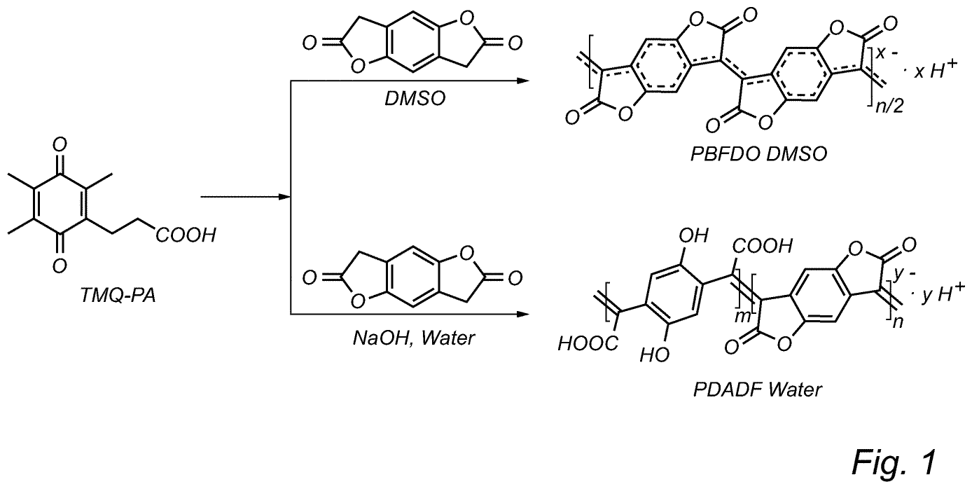

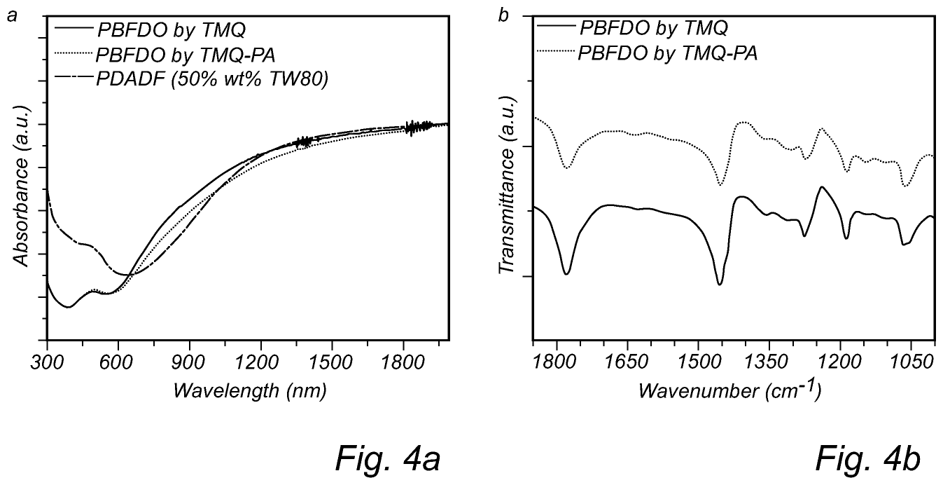

As mentioned above, catalytic efficiency of TMQ-PA to oxidize HBFDO was investigated and compared to TMQ by synthesizing PBFDO in DMSO following the procedure outlined by Tang and co-workers (FIG. 2c). The Fourier-transformed infrared (FTIR) spectra of PBFDO produced by TMQ-PA and TMQ exhibit identical absorption features, including the characteristic carbonyl peak at 1781 cm-1, along with an indistinguishable fingerprint region (FIG. 4b). However, attempts to synthesize PBFDO by reacting TMQ-PA with HBFDO in water were unsuccessful due to the still limited solubility of TMQ-PA in water (FIG. 2d). This issue was resolved by introducing 1 eq sodium hydroxide (NaOH), resulting in the formation of the water-soluble sodium 3-(2,4,5-trimethyl-3,6-dioxocyclohexa-1,4-dien-1-yl) propanoate (TMQ-PANa) and complete dissolution of TMQ-PA in water. The addition of 1 eq of HBFDO to the aqueous TMQ-PANa solution resulted in the formation of PDADF, shown in FIGS. 1 and 3b as a partially ring-opened PBFDO co-polymer structure. Notably, upon reaction with HBFDO, TMQ-PANa precipitates as the water-insoluble 6-hydroxy-5,7,8-trimethylchroman-2-one (HTMCO) and can be recovered by solvent extraction using a mixture of water and diethyl ether. Proton nuclear magnetic resonance (¹H NMR) performed on the extracted compounds revealed a TMQ-PA:HTMCO ratio of approximately 1:1.4 (FIG. 3c). HTMCO can be re-oxidized to TMQ-PA using the same synthetic procedure in FIG. 3a, allowing for a 74% recovery of the initial oxidant with purity >99%.

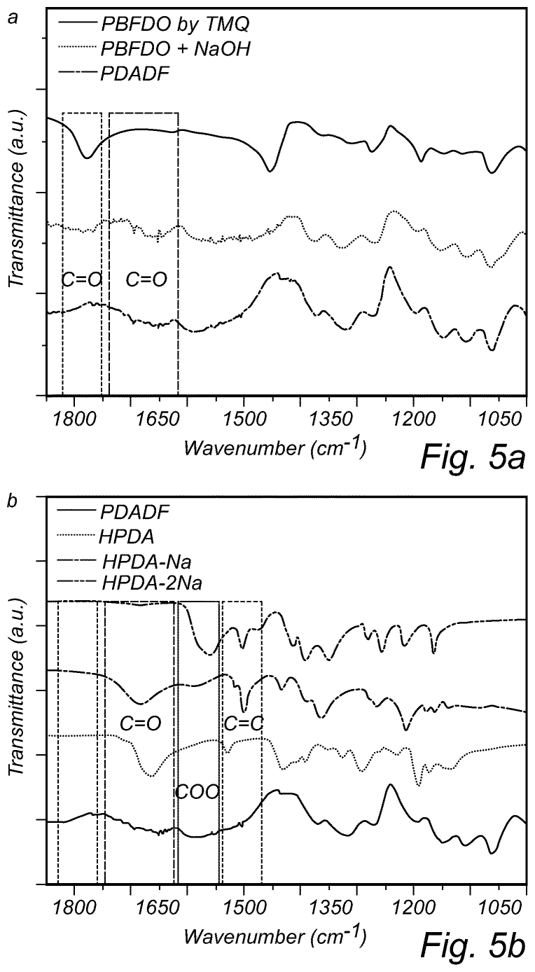

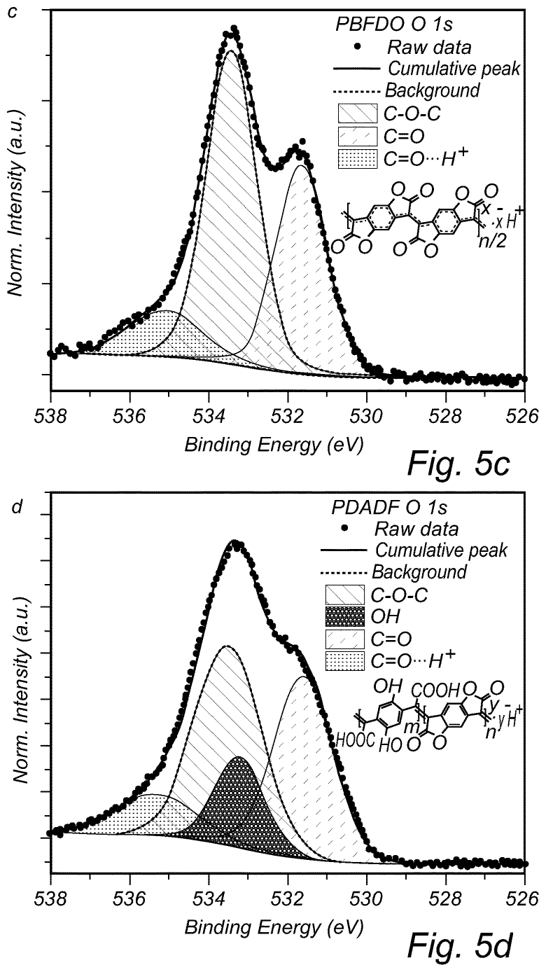

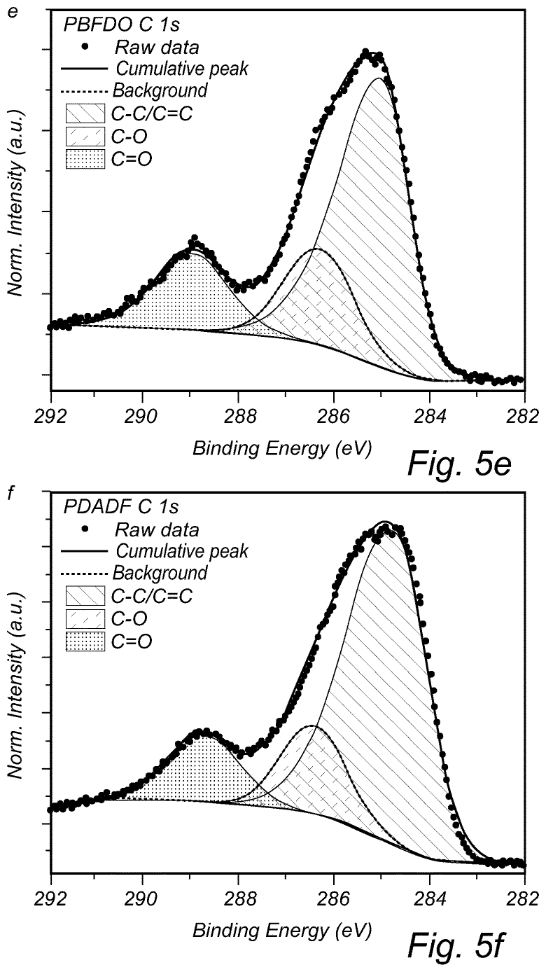

The chemical structure of PDADF and its differences with PBFDO were investigated. The FTIR spectrum of PDADF exhibits several distinct features when compared to PBFDO (FIG. 5a). While the latter displays a noticeable C═O stretching of the lactone moiety at 1781 cm⁻¹, PDADF lacks a clear peak in the same region. Additionally, three broad features in the range of 1850-1776 cm⁻¹, 1752-1624 cm-1, and 1623-1471 cm⁻¹ are observed. The features in the highlighted region at 1752-1624 cm⁻¹ are attributed to the characteristic band of a carboxylic acid group. These features are qualitatively similar to those observed in the FTIR spectrum of the HBFDO monomer treated with 1 eq NaOH, which is known to be unstable in aqueous alkaline environments and undergo ring opening, leading to the formation of sodium 2-(4-(carboxymethyl)-2,5-dihydroxyphenyl)acetate (HPDA-Na). This observation is also consistent with the reduction of pH measured before (11.59) and after (4.98) polymerization. The addition of 1 eq NaOH to an aqueous dispersion of PBFDO polymerized by TMQ in DMSO reveals similar FTIR absorption features to those of PDADF, corroborating the existence of at least a partially open-ring structure in PDADF (FIG. 5a).

In an attempt to further understand the FTIR spectra of PDADF, PDADF was compared with 2,2′-(2,5-dihydroxy-1,4-phenylene)diacetic acid (HPDA) and its Na substituted derivatives (HPDA-Na and HPDA-2Na, FIG. 5b). ¹H NMR analysis revealed minimal differences upon Na substitution of HPDA. The FTIR spectrum of HPDA-Na indicates the generation of a new asymmetric COO— vibration [vas (COO—)] at around 1621-1542 cm⁻¹, which becomes more pronounced upon further carboxylic acid deprotonation for HPDA-2Na. This vas (COO—) peak, in conjunction with a broadened peak in the pink region (1545-1462 cm⁻¹) corresponding to C═C stretching, underlies the features observed in PDADF (1621-1462 cm⁻¹). The broader C═C stretching in PDADF, compared to HPDA derivatives, is to be expected from the formation of new C═C bonds between methylene groups during polymerization. The absorption of the C═C bond vibration in PBFDO is similarly broad (FIG. 5a, ~1450 cm⁻¹). Furthermore, the characteristic band of the carboxylic acid group (1752-1624 cm⁻¹) gradually shifts and lowers in intensity upon progressive Na substitution of HPDA, which explains the broad features exhibited by PDADF in this region.

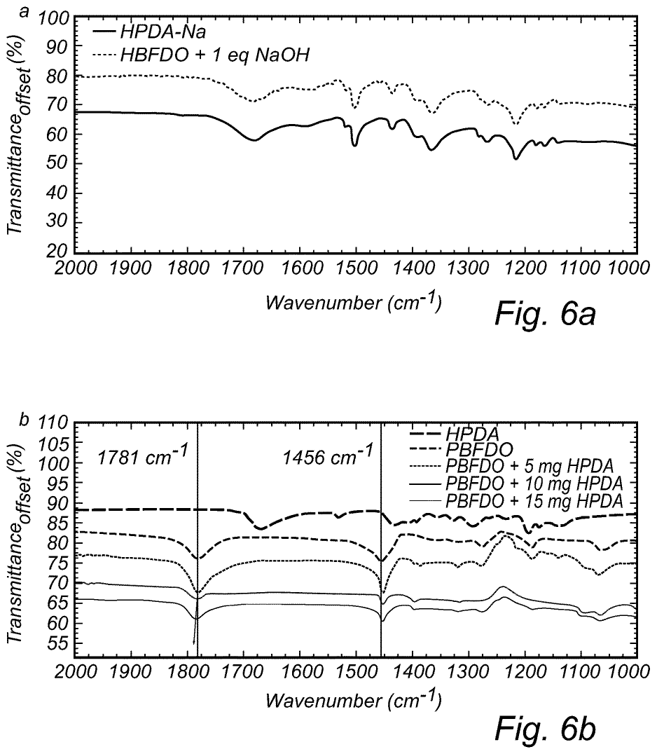

To gain further insights into the PDADF's structural differences in relation to PBFDO and the absence of a clear lactone C═O peak in PDADF's FTIR spectrum, PBFDO was mixed with different mass ratios of HPDA. A shift in the peak position of the C═O vibration at 1781 cm⁻¹ was observed upon adding HPDA in larger quantities (FIG. 6b). This corresponds to a strengthening of the C═O vibration which we hypothesized to occur when the H+ in doped PBFDO is in contact with a COO—(H+)/OH group on HPDA. The change is relatively minor due to the difficult incorporation of HPDA into the PBFDO, signified by white crystals observed after film drying. In a film of partially ring-opened polymer, however, the lactone C═O groups will be at varying proximity to COO—(H+)/OH groups, expected to amount to a broadening and significant shift of the lactone C═O vibration. Based on these results, we hypothesize that the lactone C═O vibration of PDADF has broadened and shifted to higher wavenumber compared to PBFDO resulting in the absorption observed at ~1800 cm-1 (FIG. 5a).

X-ray photoelectron spectroscopy (XPS) was carried out for additional characterization of the PDADF chemical structure. The XPS O(1s) spectra of PDADF can be fitted with an additional peak at 533.2 eV (OH on phenol), in contrast to PBFDO (C═O at 531.7 eV, C—O—C at 533.4 eV and C═O—H+ at 535.1 eV). This observation indicates that PDADF has a more complex chemical structure (FIG. 5c,d). Consequently, the C═O peak in PDADF is broader and has a larger area compared to PBFDO, suggesting the combined presence of C═O from both ring-opened carboxylic acid and ring-closed lactone moieties (FIG. 5d). The C═O—H+ peak, corresponding to the doped state of protons attached to the C═O groups, is visible in both PDADF and PBFDO polymers.

Regarding the C(1s) spectra, PDADF and PBFDO exhibit similar fitting peaks due to a comparable chemical environment of carbon, except for the different binding energy of the C—O peak. This observation aligns with the PDADF's O(1s) spectra, showcasing existing C—OH and C—O—C peaks (FIG. 5e,f). In summary, XPS confirms that the PDADF backbone comprises both closed-ring and open-ring structures.

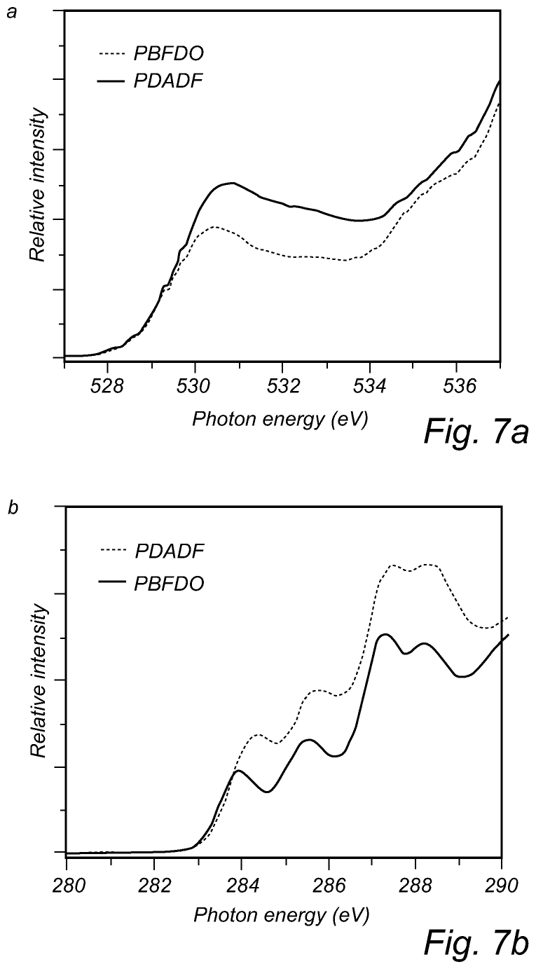

To further investigate the electronic properties of PDADF, X-ray absorption spectroscopy (XAS) was employed to probe the transition from C and O core levels to the unoccupied states of PDADF. FIG. 7 depicts the XAS spectra of C and O K-edge of PDADF compared with those of PBFDO. It is evident that the spectral features in PDADF are highly consistent with those in PBFDO. Particularly noteworthy is the similarity in the O K-edge feature, which closely mirrors that of PBFDO (FIG. 7a). This consistency is attributed to self-doping occurring in the O-related molecular structure in PBFDO, as previously reported. A slight difference is observed instead in C K-edge spectra (FIG. 7b), where the first absorption in PBFDO corresponds only to the shoulder structure, indicating a change in the C-related molecular structure in PDADF, which we attributed to the ring-opened moiety. In addition, we observed a slight upshift in the absorption energy of PDADF compared to PBFDO. Assuming the same exciton binding energy in PDADF and PBFDO, this upshift suggests a slight decrease in the Lowest Unoccupied Molecular Orbital (LUMO) energy level of PDADF. The corresponding electron affinity (EA) is lower in PDADF than in PBFDO by about 0.1 eV. In general, the similar absorption features observed for PDADF and PBFDO indicate similar electronic properties in both polymers.

Building upon the analysis of the aforementioned FTIR, XPS, and XAS data, it is proposed that the PDADF structure includes both ring-closed moieties, akin to PBFDO, and ring-opened moieties. In the latter, the lactone moiety opens, leading to the formation of carboxylic acid and phenol groups, prompting polymer dispersion in water. However, quantification of the ratio between these structures is challenging due to limitations in polymer characterization.

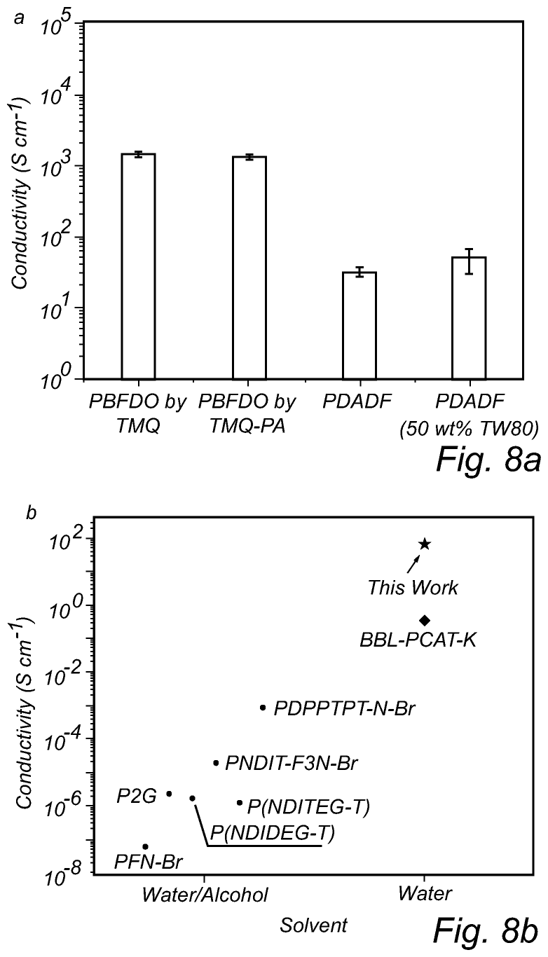

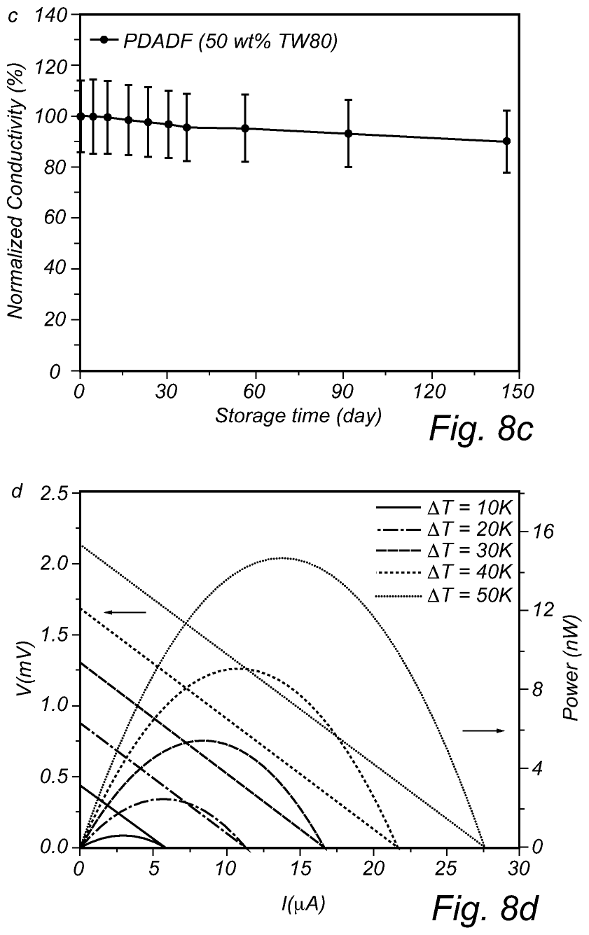

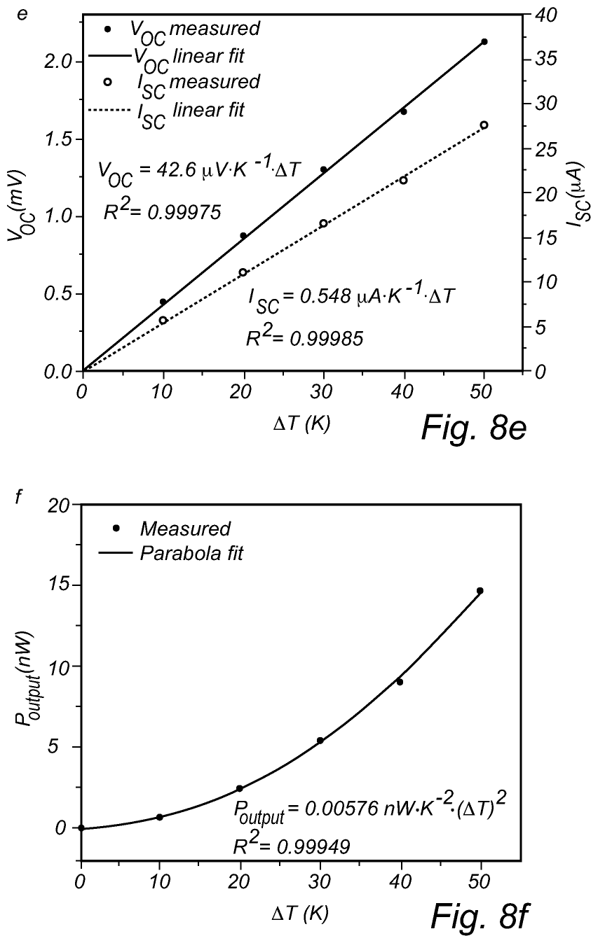

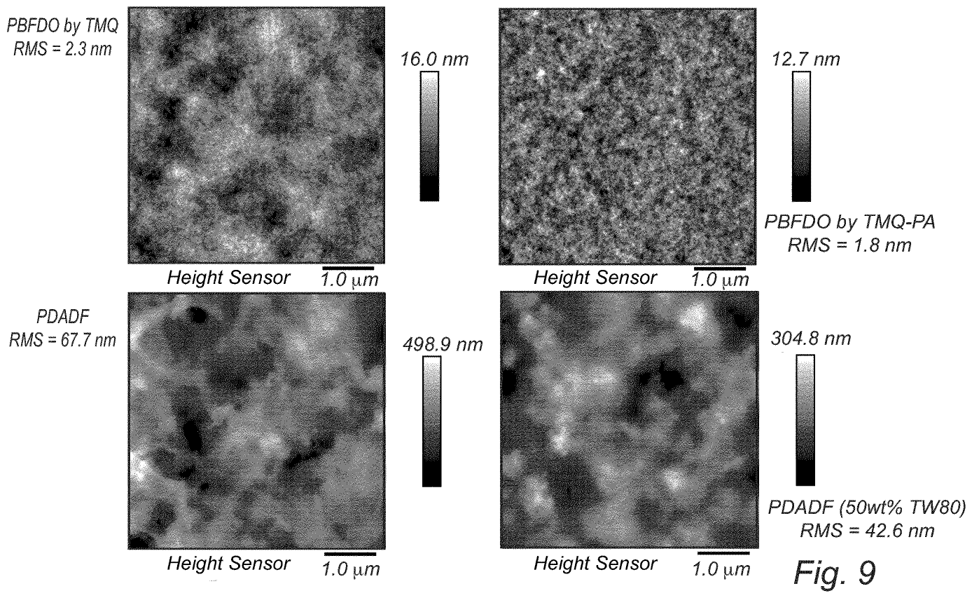

We then investigated the electrical and thermoelectric properties of PDADF and compared them to PBFDO (FIG. 8a). The electrical conductivity of PBFDO films, processed from DMSO and measured by a four-point probe method, was determined to be approximately 1379±83 S cm⁻¹ for TMQ and 1297±98 S cm⁻¹ for TMQ-PA, respectively. This result confirms the catalytic efficiency of TMQ-PA to oxidize HBFDO in DMSO. In contrast, PDADF films drop-casted from water exhibited a lower electrical conductivity of 30.9±4.6 S cm⁻¹. We attributed the reduced electrical conductivity of PDADF with respect to PBFDO to the coarse morphology of the former when compared to the latter (see FIG. 9). The use of the surfactant Tween 80 (TW80) yields more homogeneous films (FIG. 9), reaching electrical conductivities as high as 66 S cm⁻¹ (average 48±18 S cm⁻¹, see Table 2). Despite these values being lower than those measured for PBFDO in DMSO, they are the highest reported for n-type conducting polymers synthesized and processed from water or water/alcohol mixtures (FIG. 8b) and among the highest for n-type conducting polymers entirely processed in ambient conditions. Remarkably, the electrical conductivity of PDADF synthesized using recycled TMQ-PA is on par with that of PDADF produced using freshly synthesized oxidant (Table 2, entry 4), highlighting the robustness and effectiveness of the recycling process.

TABLE 2
Summary of the electrical conductivity values.

| | | | | | Surfac- | Conductivity |
|---|---|---|---|---|---|---|
| Entry | Polymer | Catalyst | Solvent | Base | tant | (S cm⁻¹) |
| 1 | PBFDO | TMQ | DMSO | — | — | 1379 ± 83 |
| 2 | PBFDO | TMQ-PA | DMSO | — | — | 1297 ± 98 |
| 3 | PDADF | TMQ-PA | H₂O | NaOH | — | 30.9 ± 4.6 |
| 4^{[a]} | PDADF | TMQ-PA | H₂O | NaOH | — | 30.8 ± 4.8 |
| 5 | PDADF | TMQ-PA | H₂O | NaOH | TW80 | 48 ± 18 |
| | (50 wt % | | | | | |
| | TW80) | | | | | |

^{[a]}PDADF synthesized from recycled TMQ-PA.

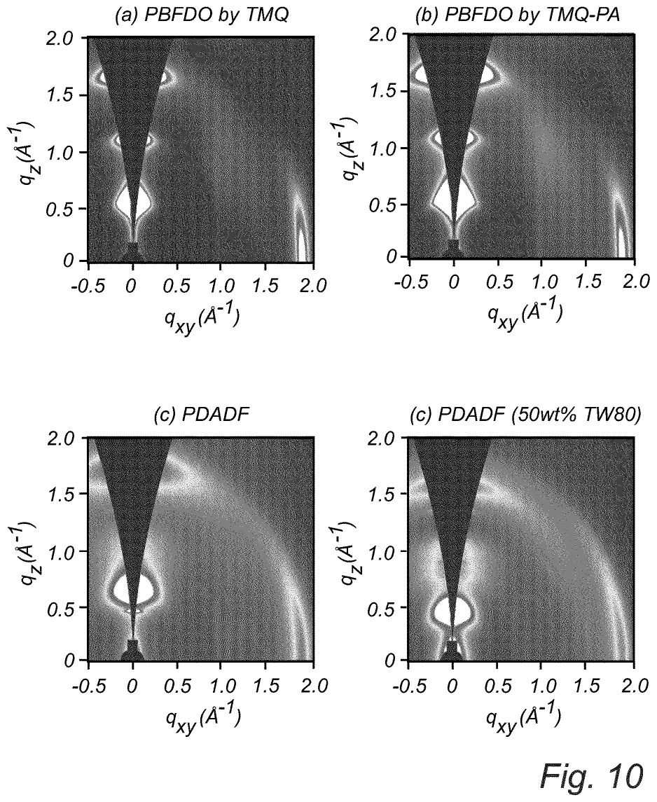

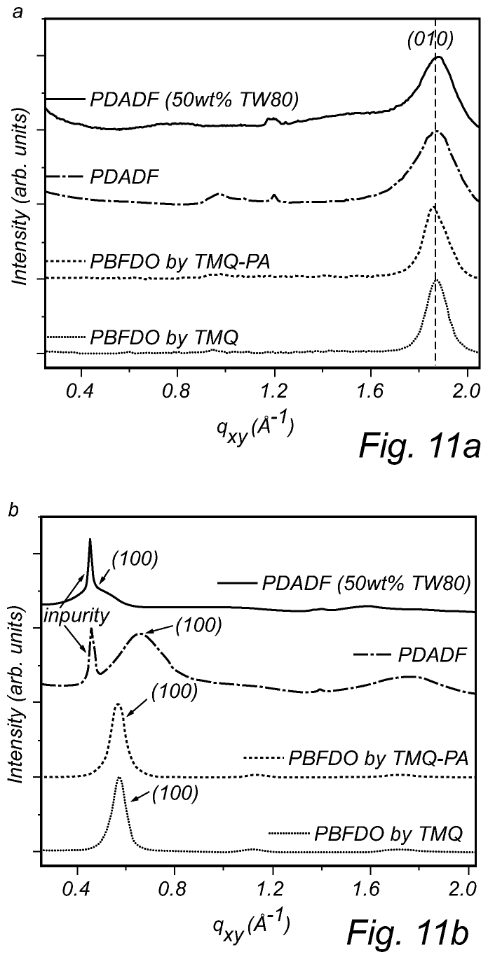

The grazing-incidence wide-angle X-ray scattering (GIWAXS) reveals that PBFDO and PDADF film demonstrate similar edge-on stacking orientation on the substrates, where PDADF shows a weaker π-π stacking (010) signal compared to PBFDO (FIG. 10 and FIG. 11). PDADF exhibits a lamellar packing at q_{z}=0.657 Å⁻¹ (d-spacing=9.53 Å), increasing to a d-spacing of 13.46 Å with the addition of TW80 (FIG. 11b). Additionally, both PDADF and PDADF (50 wt % TW80) exhibit diminished π-π stacking crystallinity with a decreased coherence length and increased paracrystalline disorder, both in-plane or out-of-plane, compared to PBFDO (Table 1).

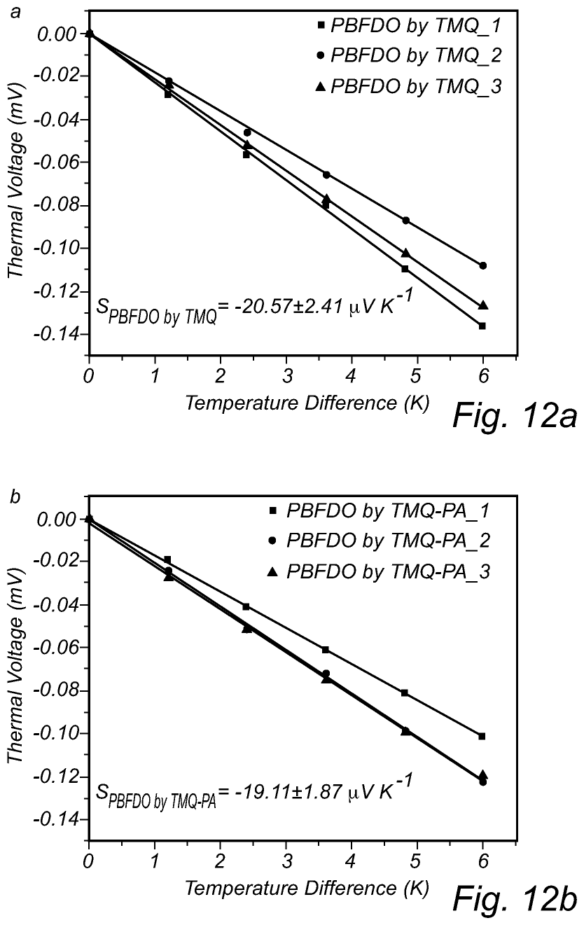

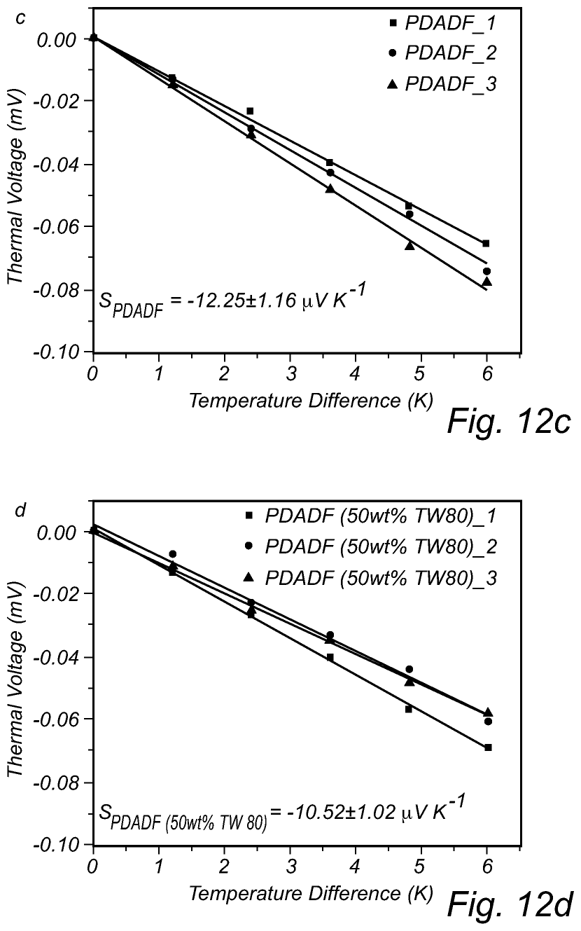

The Seebeck coefficient of PDADF was found to be −12.25±1.16 ρV K⁻¹ (FIG. 12). This value slightly reduces to −10.52±1.02 pV K⁻¹ when TW80 is used as the surfactant. For comparison, the Seebeck coefficient of PBFDO films was found to be around −20 μV K⁻¹, in agreement with previous reports. The negative sign of the Seebeck coefficient values is consistent with electrons being the majority charge carriers.

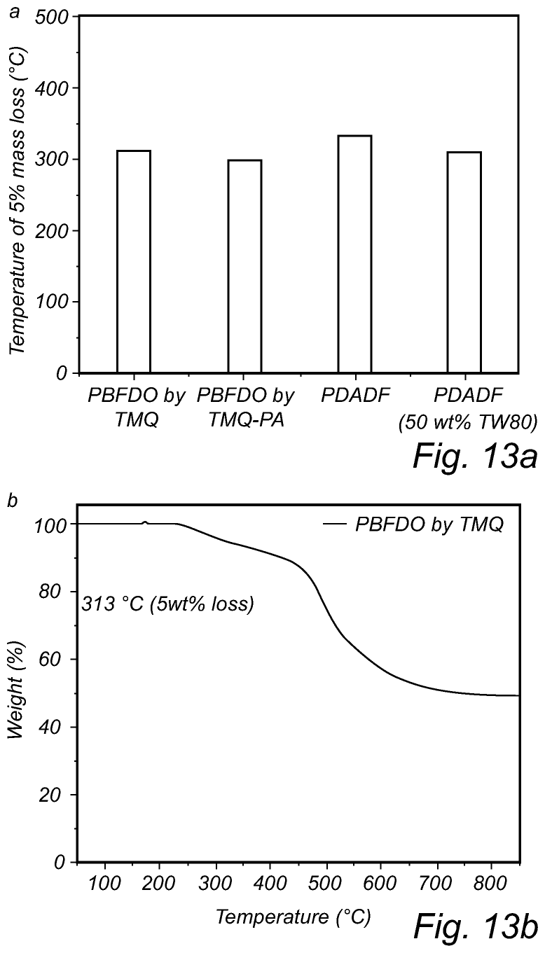

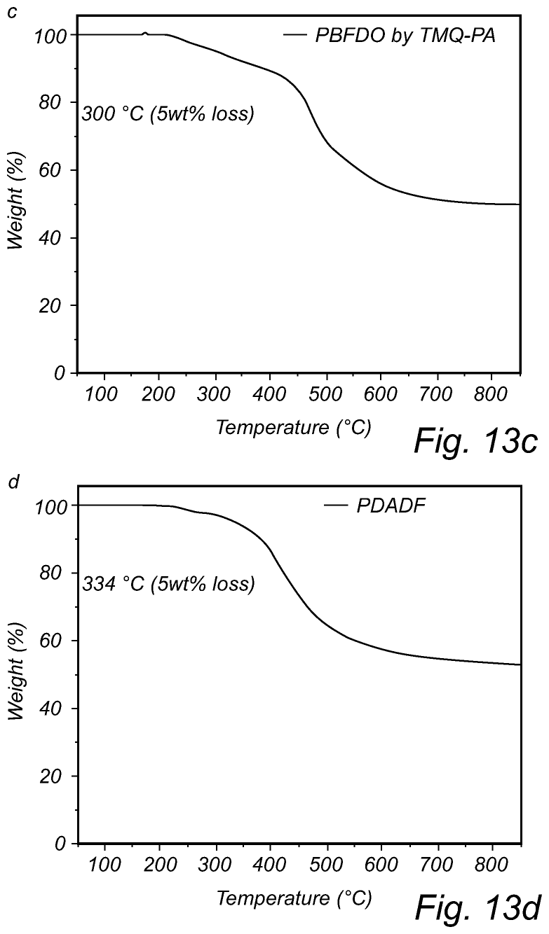

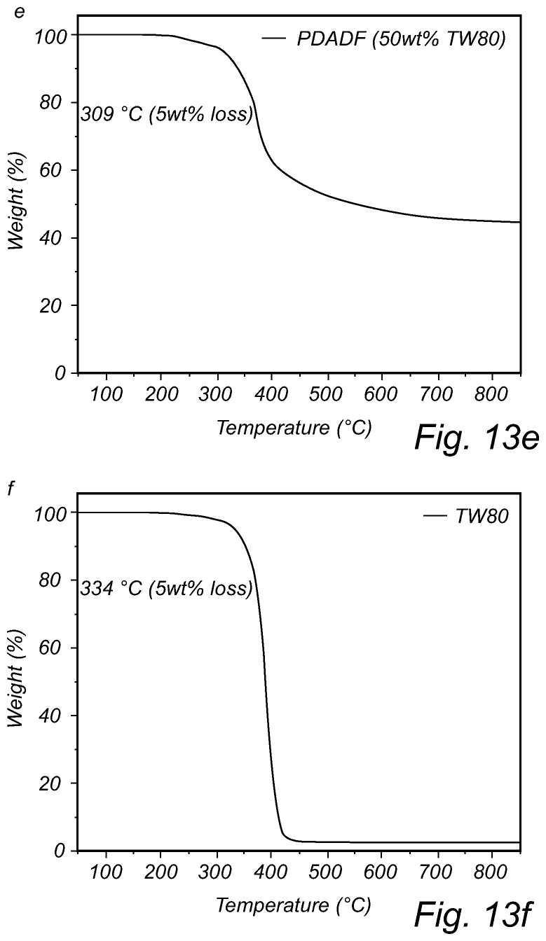

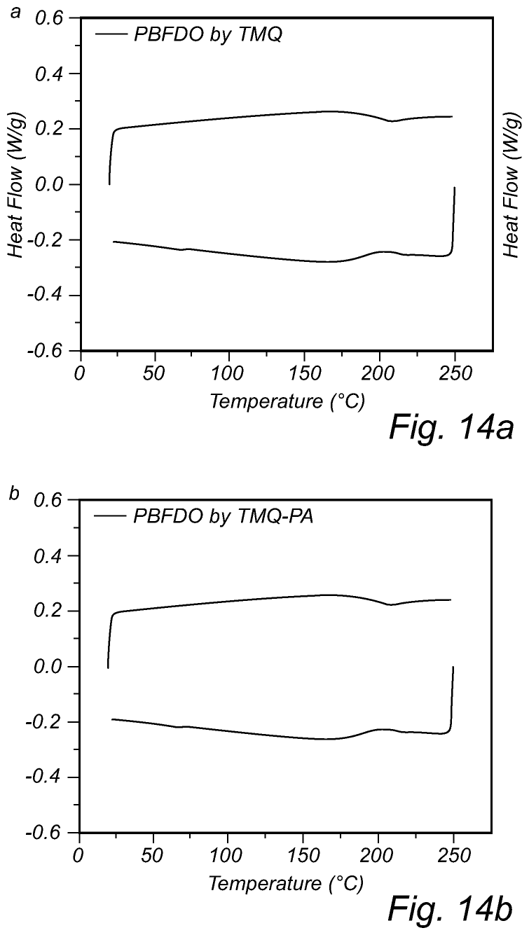

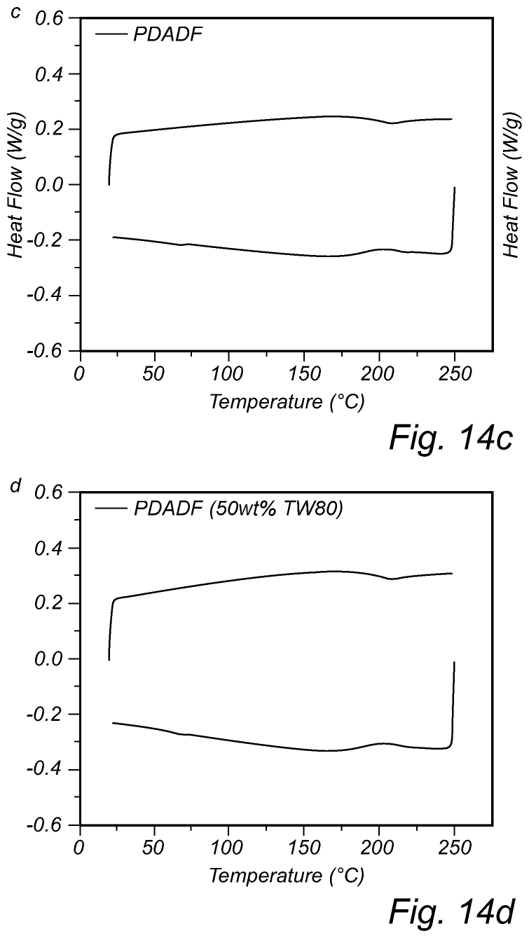

Typically, n-type conducting polymers are susceptible to degradation when processed and operated in air. This degradation is primarily attributed to the quenching of radical anions by atmospheric moisture and oxygen. The air stability of PDADF films was studied by monitoring variations in electrical conductivity over time and under ambient conditions. Thin films of PDADF (71±9 nm thick, 50 wt % TW80) exhibited an impressive 90% retention of the electrical conductivity after 146 days (FIG. 8c). This result is particularly noteworthy for n-type conjugated polymers synthesized and processed entirely from water. Additionally, PDADF demonstrates good thermal stability and no observable phase transition (FIGS. 13 and 14).

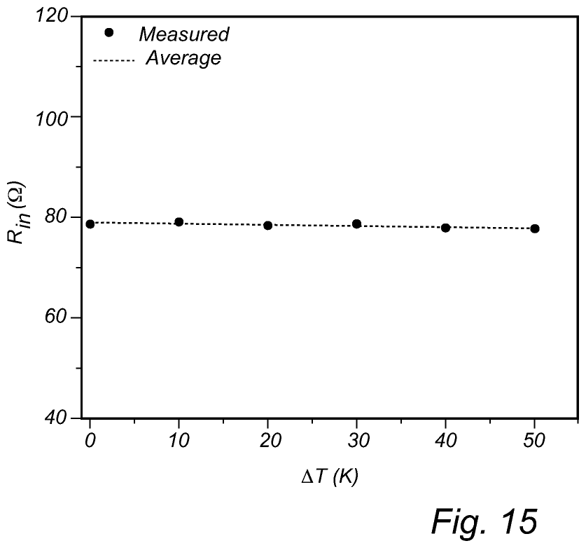

Next, we evaluated the possibility of fabricating the first all-polymer, water-processable, flexible organic thermoelectric generators (OTEGs). An aqueous dispersion of PDADF (50 wt % TW80) was used to fabricate the n-leg, while PEDOT:PSS (5 wt % EG) was used as the p-leg. A polyethylene naphthalate (PEN) foil (100 μm thick) was used as the flexible substrate, with gold electrodes patterned on it via evaporation through a shadow mask. Subsequently, PDADF and PEDOT:PSS were drop-casted through a mask. Importantly, all processes and measurements were conducted in air without encapsulation. These flexible OTEGs processed from water exhibit an internal resistance of 78 ohms (FIG. 15) and demonstrate open-circuit voltage and short-circuit current responses linearly proportional to the applied temperature gradient, with a remarkable thermovoltage of 42.6 μV K⁻¹ (FIG. 8e). The power output per p-n pair of the TEG exhibits a quadratic relationship with the temperature gradient, ranging from 0.25 nW (ΔT=10 K) to 14.7 nW (ΔT=50 K).

According to a particular embodiment of the present invention, the catalyst may be synthesized as follows. Methane sulfonic acid (10 mL) was heated to 70° C. in an oil bath, 2,3,5-trimethylbenzene-1,4-diol (1 g, 6.57 mmol) and tert-butyl acrylate (1.09 mL, 7.42 mmol) were added under stirring. The reaction continued at 70° C. for 90 min, then the mixture was diluted to 100 ml water and extracted with ethyl acetate 3 times. The extracts were washed with water, saturated NaHCO₃, saturated NaCl, and dried (Na₂SO₄). The solvent was removed by a rotary evaporator. The residue was purified by silica gel chromatography to afford the pure solid lactone HTMCO (0.81 g, 60% yield). To a solution of lactone 6-hydroxy-5,7,8-trimethylchroman-2-one (HTMCO) (1.8 g, 8.73 mmol) in 90 mL 10% Aqueous acetonitrile was added dropwise of a solution of NBS (1.63 g, 9.16 mmol) in 18 mL acetonitrile. The reaction mixture was stirred for 1 hour at 25° C. and the solvent was removed by rotary evaporator. The residue was diluted with water and extracted with several portions of ether. The combined ether extracts were washed with water, brine, and dried (used Na₂SO₄). Removal of solvent and crystallization (acetone-hexane) afforded 1.5 g product TMQ-PA (80% yield).

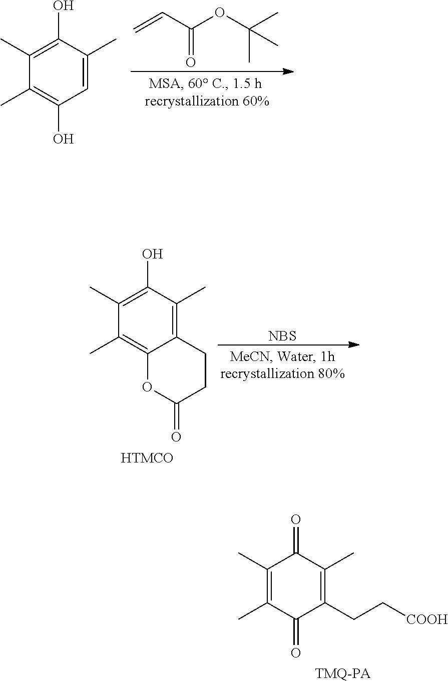

The PDADF water ink were synthesized as follows. TMQ-PA (7.89 mmol, 1.75 g, 1 eq) was added to a 250 mL round-bottom flask with stir bar, following by freshly made 0.5 M NaOH (7.89 mmol, 15.8 mL, 1 eq), and stirred at room temperature (RT) for 10 mins until all TMQ-PA dissolved. Another 42.5 mL DI water was added to the solution, forming 30 mg/mL dispersion according to monomer HBFDO. HBFDO (7.89 mmol, 1.50 g, 1 eq) was added to the diluted solution and stirred at 100° C. for 3.5 h. The final suspension was diluted with water after cooling down to RT, extracted with diethyl ether for 5 times until the organic phase was colorless. All the diethyl ether collected and purified by column chromatography to get the recycled mixture of catalyst and its precursor, following by the oxidation to yield TMQ-PA. The PDADF aqueous phase was collected by centrifugation (6000 rpm for 10 min) and washed with DI water for another 5 times. PDADF was collected from bottom of the centrifuge tube and form about 20 mg/mL water dispersion for, drop-casting, and other thin film processing methods.

PDADF (50 wt % TW80) was synthesised as follows. PDADF was synthesized based on the same aforementioned method, followed by the addition of 0.75 g TW80 (0.5-time mass multiple according to HBFDO). The mixture was stirred for another 2 days to form the final PDADF (50 wt % TW80) water ink.

The method of the present invention thus successfully and unexpectedly yields poly(2,2′-(2,5-dihydroxy-1,4-phenylene)diacetic acid) (PDADF) water ink in its doped state (FIG. 2e). The resulting PDADF exhibits remarkable electrical conductivity, reaching an impressive 30.9 S cm⁻¹. Furthermore, the addition of the surfactant TW80 to the PDADF water ink forms PDADF (50 wt % TW80), elevating the drop-casting film conductivity to a maximum of 66 S cm⁻¹ (mean 48±18 S cm⁻¹). Remarkably, the spin-casting film retains a conductivity of 16 S cm⁻¹, demonstrating state-of-the-art air stability, with 90% conductivity retention after an astounding 147 days in ambient air, without any encapsulation. Moreover, the catalyst TMQ-PA exhibits exceptional recyclability, yielding 74% recovery during water polymerization. Utilizing recycled catalyst, the PDADF film maintains the same high conductivity. Additionally, TMQ-PA proves versatile and efficient in PBFDO polymerization, delivering comparable performance. To illustrate the practicality of PDADF, the inventors demonstrated its application as the n-type component in thermoelectric generators (TEGs), achieving a maximum power output of 14.7 nW at a temperature differential (AT) of 50 K, equivalent to one p-n pair. We anticipate that the water-based n-type PDADF ink will find widespread applications due to its water-processability, cost-effectiveness, recyclable catalyst, and excellent electrical conductivity. This ink holds particular promise for complementary hole and electron-based devices, such as TEGs and bioelectronic devices.

Although the present invention has been described with reference to various embodiments, those skilled in the art will recognize that changes may be made without departing from the scope of the invention. It is intended that the detailed description be regarded as illustrative and that the appended claims including all the equivalents are intended to define the scope of the invention.

TABLE 1

| | π-π stacking | | | | | Lamellar stacking | | |
|---|---|---|---|---|---|---|---|---|
| | q_{xy} | q_{xy} | Coherence | Paracrystalline | q_{z} | q_{z} | Coherence | Paracrystalline |
| | (010) | (010) | length | disorder | (100) | (100) | length | disorder |
| Polymers | (Å⁻¹) | (Å) | (Å) | (Å) | (Å⁻¹) | (Å) | (Å) | (Å) |
| PBFDO by TMQ | 1.871 | 3.358 | 24.63 | 0.1390 | 0.5688 | 11.046 | 42.492 | 0.1919 |
| PBFDO by TMQ-PA | 1.862 | 3.375 | 19.11 | 0.1582 | 0.5657 | 11.107 | 37.73 | 0.2042 |
| PDADF | 1.867 | 3.363 | 11.86 | 0.2004 | 0.6589 | 9.536 | 11.92 | 0.3366 |
| PDADF (50 wt % TW80) | 1.874 | 3.352 | 13.03 | 0.1909 | 0.4666 | 13.465 | 13.26 | 0.3793 |

1. A method for manufacturing a water-processable n-type conducting polymer, said method comprising the steps of:
a) adding a monomer to a solvent system comprising water in the presence of a catalyst and a base, thus providing a reaction solution;
b) allowing said monomer to polymerize in said reaction solution thus obtaining an n-type conducting polymer;
c) post-treating the n-type conducting polymer dispersion thus obtaining a water-processable n-type conducting polymer.

2. The method according to claim 1, wherein said catalyst is selected from sulfonyl- and carboxyl-substituted benzoquinones.

3. The method according to any one of the preceding claims, wherein said catalyst is selected from a group consisting of: 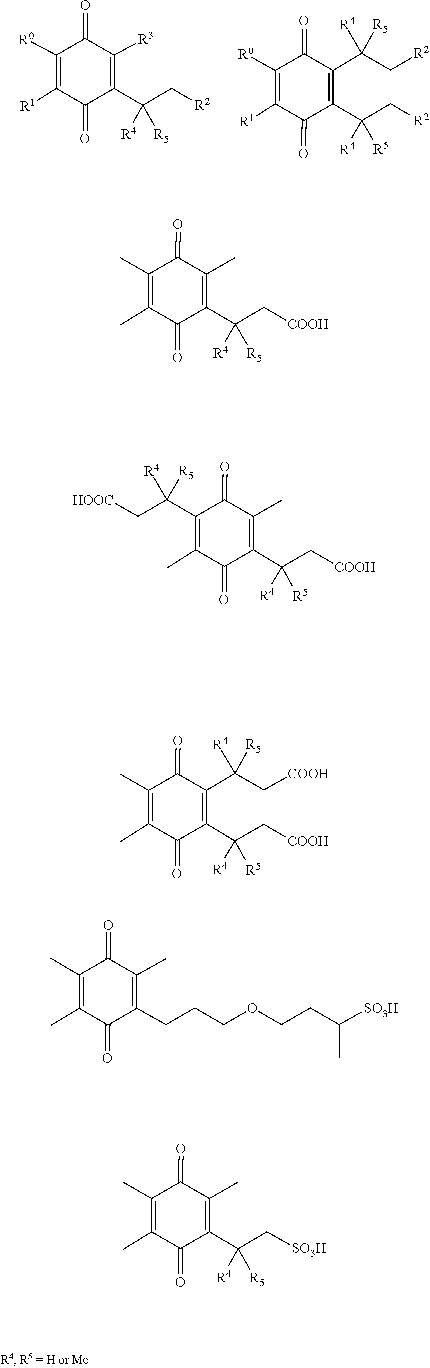
wherein R₀, R₁ and R₃ are independently H, Me, or —CH₂R₄R₅COOH;
R₄, R₅ are independently H or Me;
R₂ is —COOH or —SO₂OH.

4. The method according to any one of the preceding claims, wherein said catalyst is selected the group consisting of 3-(2,4,5-trimethyl-3,6-dioxocyclohexa-1,4-dien-1-yl)propanoic acid (TMQ-PA, R⁰═R¹═R³=Me, R₄═R₅═H, R₂═—COOH), 3,3′-(4,5-dimethyl-3,6-dioxocyclohexa-1,4-diene-1,2-diyl)dipropionic acid (AAMMQ, R₀═R₁=Me, R₃═—CH₂R₄R₅COOH, R₄, R₅═H or Me, R₂═—COOH), 3,3′-(2,5-dimethyl-3,6-dioxocyclohexa-1,4-diene-1,4-diyl)dipropionic acid (AMAMQ, R₁═R₃=Me, R₀═—CH₂R₄R₅COOH, R₄, R₅═H or Me, R₂═—COOH) and combinations thereof.

5. The method according to any one of the preceding claims, wherein said base is MOH, wherein M is selected from Li⁺, Na⁺, K⁺, Me₄N⁺, Bu₄N⁺ or combination thereof.

6. The method according to any one of the preceding claims, said method further comprising a step of:
a′) adding a surfactant to said water-processable n-type conducting polymer.

7. The method according to any one of the preceding claims, wherein said solvent system further comprises a polar aprotic solvent, and wherein said method further comprises the step of:
d) solvent exchanging such that said polar aprotic solvent is removed.

8. The method according to claim 7, wherein said polar aprotic solvent is dimethyl sulfoxide (DMSO), dimethyl formamide (DMF), dimethyl acetamide (DMA) or a combination thereof.

9. The method according to any one of claims 7 and 8, wherein the ratio between water and said polar aprotic solvent is from 5:95 to 95:5.

10. The method according to any one of claims 7-9, wherein a surfactant is added during said step d).

11. The method according to any one of the preceding claims, wherein said step b) occurs at a temperature from 20° C. to 150° C.

12. The method according to any one of the preceding claims, wherein said monomer is 3,7-dihydrobenzo[1,2-b:4,5-b]difuran-2,6-dione (HBFDO), and wherein said n-type conducting polymer is poly[(2,2′-(2,5-dihydroxy-1,4-phenylene)diacetic acid)-co-3,7-dihydrobenzo[1,2-b:4,5-b′]difuran-2,6-dione](PDADF), poly[(2,2′-(2,5-dihydroxy-1,4-phenylene)diacetic acid) (PDADF-P), or mixture thereof.

13. The method according to any one of the preceding claims, wherein said method further comprises a step of:
c′) removing said catalyst by extraction, oxidation and recycling said catalyst.

14. A water-processable n-type conducting polymer comprising a general conjugated structure having a central symmetrical benzene ring fused with two rings, and wherein the water-processable n-type conducting polymer further comprises segments having a benzene ring comprising at least one substituent having a relatively electronegative element attached by a single bond to carbon, wherein each substituent has an acidic hydrogen.

15. The water-processable n-type conducting polymer according to claim 14, wherein said polymer is poly[(2,2′-(2,5-dihydroxy-1,4-phenylene)diacetic acid)-co-3,7-dihydrobenzo[1,2-b:4,5-b′]difuran-2,6-dione](PDADF), poly[(2,2′-(2,5-dihydroxy-1,4-phenylene)diacetic acid) (PDADF-P), or mixture thereof.

16. A water-based ink comprising the water-processable n-type conducting polymer according to any one of claims 14 and 15.
